(19) United States
(12) Patent Application Publication
(10) Pub. No.: US 2026/0181300 A1
(43) Pub. Date: Jun. 25, 2026

(54) Auricular Vagus Nerve Stimulator with Replaceable Tip

(71) Applicant: NeurGear, Inc., Rochester, NY (US)

(72) Inventors: Jonathan Taylor Hacker, Rochester, NY (US); Stanley Ward Stephenson, Spencerport, NY (US); Andrew Robert Slegaitis, Forestport, NY (US)

(21) Appl. No.: 19/531,539

(22) Filed: Feb. 5, 2026

Related U.S. Application Data
(63) Continuation-in-part of application No. 18/631,192, filed on Apr. 10, 2024.
(60) Provisional application No. 63/458,771, filed on Apr. 12, 2023.
(60) Provisional application No. 63/833,982, filed on Feb. 5, 2025.

(51) Int. Cl. H04R 1/10

(52) U.S. Cl. CPC H04R 1/1008; H04R 1/105

(57) ABSTRACT

A headset apparatus for a user comprising a headband configured to secure the headset to a user's head, an ultrasound transducer on said apparatus configured to press against the auricular vagus nerve, and a replaceable conformal pad over the ultrasound transducer having features conforming to the surface of the ear over the auricular vagus nerve.

### CROSS REFERENCE TO RELATED APPLICATIONS

This application is a nonprovisional conversion of and claims priority to U.S. Provisional Application 63/833,982 filed Feb. 5, 2025, the entirety of which is incorporated by reference herein.

This application is also a continuation-in-part of and claims priority to U.S. Nonprovisional application Ser. No. 18/631,192 filed Apr. 10, 2024, which is a nonprovisional conversion of U.S. Provisional Application No. 63/458,771 filed as a provisional patent application on Apr. 12, 2023, entitled “ULTRASONIC AURICULAR VAGUS NERVE STIMULATOR”, which are incorporated herein in their entirety.

### FIELD

The present disclosure relates generally to therapeutic stimulation using ultrasonic radiation and more particularly to ultrasound stimulation of the vagus nerve at the ear and coupling methods between ultrasonic transducers and a user.

### BACKGROUND

In human anatomy, the vagus nerve is the tenth cranial nerve that relays sensory and motor information between the brain and organs in the chest and abdomen. The auricular branch of the vagus nerve Va lies within the tissue of both outer ears, as represented in the schematic view of FIG. 1, with representative portions of vagus nerve branches shown in enlarged inset K. The vagus nerve V is considered part of the parasympathetic nervous system regulating and responding to conditions related to rest and digestion of the human subject. Stimulation of the vagus nerve, such as electrical stimulation, is widely held to improve overall well-being of the subject. Va is a branch of the vagus nerve V that lies behind each ear. The area of the auricular nerve is shaded in inset K.

Vagus nerve stimulation has been approved by the Food and Drug Administration (FDA) to treat some forms of epilepsy, as well as depression. For some conventional methods of vagus nerve stimulation (VNS) treatment, healthcare providers implant a small electrical device in the chest, under the skin, to send mild, painless electrical signals through the left vagus nerve to the brain. These impulses can be shown helpful in calming irregular electrical activity in the brain.

There is accumulating evidence to suggest that vagus nerve stimulation can help to quell inflammation related to a number of other autonomic or inflammatory disorders, which would make it useful for a wide range of adult and pediatric patients.

In some early therapeutic work for neural stimulation, a set of conductive pads was attached to the body and a control mechanism to apply transdermal electrical shocks to a patient's limbs. A series of DC pulses can be applied to an area for a given period of time. In this sequence, a second time period with no stimulation passes, then a third interval of stimulation occurs, with reversed DC voltage. This process was shown to alleviate pain very rapidly.

Other earlier work discloses use of electrical shock to the auricular vagus nerve. In one embodiment, non-invasive electrodes are mounted on skin surfaces in the ear. One electrode is placed outside the ear conch and the second electrode is placed in the external auditory canal, implanted to excite the vagus nerve. A controller is connected to an electrical stimulation circuit and is adapted to provide vagus nerve stimulation. A feedback circuit based on physiological response can control the applied stimulation. The use of electrical shock, however, can be uncomfortable and can lead to neural scarring that reduces therapeutic value.

Still other work discloses modulating neural activity by using a reversible blocking condition of peripheral neural structures. The reversible blocking process is applied when the subject is in a first state, and deactivated when the subject is in a second state. External sensing components are used to detect neural activity and control the blocking energy. Certain embodiments disclose implanted sensors and antennae to sense and conduct therapeutic energy. Such types of apparatus can be applied over the surface of the extremities, including arms, legs, and fingers. However, the vagus nerve is embedded deeply into the neck, so that such a method can require surgical procedure in order to be reached with sufficient electrical signal.

In one earlier, non-invasive method of exciting the vagus nerve, the user presses a set of electrodes to the skin of the neck to provide electrostimulation of the Vagus nerves. The stimulation device interconnects with apparatus that records the therapy session. The information can be provided to medical personnel to monitor the therapeutic regime. The apparatus applies electrical energy in the form of an AC sinewave that is applied over periodic time intervals. However, contact pressure factors are not well-defined and providing sufficient electrical stimulation to stimulate the vagus nerve can be painful for the subject.

More recent work has applied focused ultrasonic energy for peripheral nerve modulation. The nerve is then stimulated by focused ultrasound in order to modulate peripheral nerves, such as nerves in arms or legs. The ultrasound probe can use an imaging process to observe tissue deformation due to the focused ultrasound energy.

Another more recent apparatus is attached to the subject's head for stimulating the auditory system. An ultrasound transmitter is held to the exterior of the head to focus ultrasound onto the cochlea, which is located deeply into the skull. An embodiment shows the device is located on the temple near the external ear canal and oriented to direct energy to the cochlea. Multiple transducers can be located on the headband for stimulation. In an embodiment, a plug is inserted into the ear canal and excited by a device housed behind the ear. The device within the ear canal emits ultrasonic radiation radially into the skull. The apparatus receives audible sound, translates that sound into one or more ultrasonic frequencies and directs the ultrasonic radiation at those frequencies to the cochlea to create a perception of sound to the user.

In yet other work, a garment supports a stimulating device for the subject. The particular stimulation devices can include vibration or audible sound to effect positive therapy. The garment can cover the subject's chest, abdomen, arms or legs. In one embodiment, an acoustic speaker is supported on a frame that directs sound energy towards the user head. Other embodiments disclose a single speaker located on the subject's body. The stimulation devices are disclosed as providing acoustic, vibration, or electrical pulses delivered through contact with the skin. The stimulators are activated in response to external command from such sources as smart phone or computer games, for example.

Among other devices and configurations for stimulating the auricular vagus nerve, one approach uses a wearable neural stimulation device attached to the ear. The neural stimulator can use any type of energy, including mechanical, electrical, magnetic, ultrasound, optical, thermal or chemical energy. The supporting frame can support multiple stimulators in various areas of the ear. In one embodiment, the stimulation occurs in both ears through stimulators supported by a single frame. A member wraps around the back of the ear to secure the device to the ear and a neural stimulator operates in response to commands for a processor. The processor receives commands from a remote communication system. An audio speaker can be incorporated to provide audio information to the user.

Ultrasound therapy has been applied to muscle tissue to ease pain. An ultrasound transducer can provide mild heat and pulsed mechanical pressure to ease pain in muscles. The ultrasound transducer is typically coupled with an ultrasound oil or gel to improve energy transmission to the afflicted tissue. The coupling gel is formulated to have physical properties similar to water. The coupling medium can be a gel, a thick, conductive substance that's typically made of water with a viscosity increasing agent, such as propylene glycol. Propylene glycol is a synthetic compound that's often found in food, cosmetics, and hygiene products. Other thickeners that may be found in ultrasound gel include glycerin, Carbomer, Sodium Hydroxide, Diazolidinyl Urea, Methylparaben, Disodium EDTA, Propylparaben coconut, and hemp oil. Such oils are applied to the ultrasound probe, which is in turn applied to a target area on a user's body.

Replaceable ultrasound covers are used to provide a new and sanitary surface to each user. Covers exist can be a sheet of thin plastic or a thicker sheet of silicone rubber to interface between the ultrasound probe and a user. One commercial example is the PEELSafe Advantage ultrasound probe cover. An adhesive can be on a surface of the cover to selectively attach and detach the cover to the probe. The adhesive can be formulated to attach the cover to the probe, but also be a weak enough attachment to permit release of the cover from probe. The materials used on the cover and adhesives should be formulated to minimize attenuation and diffraction of ultrasound energy.

### SUMMARY

It is an object of the present disclosure to advance the art of stimulating the vagus nerve. Embodiments of the present disclosure provide non-invasive and readily usable vagus nerve stimulation with an apparatus that provides ultrasound energy to the auricular vagus nerve.

With this object in mind, the present disclosure provides a headset apparatus for a subject comprising: an ultrasound transducer in a holder attached to a user wherein the ultrasound transducer is configured to press against the auricular vagus nerve, and a replaceable cover over the ultrasound transducer having features conformal to the surface of the ear over the auricular vagus nerve.

These objects are given only by way of illustrative example, and such objects may be exemplary of one or more embodiments of the disclosure. Other desirable objectives and advantages inherently achieved by the disclosed disclosure may occur or become apparent to those skilled in the art. The invention is defined by the appended claims.

More specifically, the present disclosure provides for a headset for a user comprising:
(a) a headband configured to secure said headset to a user's head;
(b) one or more ultrasound transducers on said headset configured to press against an auricular vagus nerve; and
(c) a replaceable conformal pad over said ultrasound transducers that contacts a surface of an ear over said auricular vagus nerve.

Here the conformal pad has features that conform to a surface of an ear over said auricular vagus nerve. In addition the conformal pad can be comprised of an elastomer.

The headset includes details of said replaceable conformal pad aligns said conformal pad to said surface of the ear over the auricular vagus nerve when attached to said headset.

The conformal pad is enclosed in a sterile package wherein:
(a) said conformal pad has ultrasound transmitting gel on a surface contacting an ear; and
(b) said conformal pad supports ultrasonic conducting gel on a surface receiving ultrasonic energy.

The headset provides gel in contact with a pinna contains psychotherapeutic substances.

The headset includes an alignment feature spaced apart from said transducer and configured to seat within an ear canal to position the transducer assembly against a pinna surface.

Here the ultrasound transducer comprises a piezoelectric element embedded in epoxy.

The piezoelectric element is formed from PZT-5A.

The conformal pad is formed from liquid silicone rubber (LSR) having a hardness of approximately 40A Shore durometer.

It is possible a controller configured to provide ultrasonic energy during a first time period and discontinue excitation during a second time period in a therapeutic cycling sequence.

Here the headset includes a duty cycle is approximately 50% with excitation and relaxation times of approximately 30 msec each.

The headset includes a transducer assembly that has a center frequency at or about 8 MHz.

The headset further comprising a speaker configured to provide an audible signal indicating active ultrasound emission.

The headset and the conformal pad includes a skirt portion configured to grip a frame, wherein the skirt portion is molded slightly smaller than contact areas on said frame such that the skirt stretches to create a securing force.

The headset includes a conformal pad includes an alignment detail configured to engage a corresponding frame detail to rotationally orient said conformal pad relative to said pinna surface.

The headset of claim further comprises a pair of ultrasound transducer assemblies configured for simultaneous stimulation of both ears.

A replaceable conformal pad for an auricular vagus nerve stimulator comprising:
(a) an elastomeric body having a contact surface shaped to conform to a crux of helix of a pinna;
(b) a skirt portion configured to grip a frame of said nerve stimulator; and
(c) an alignment detail configured to engage a corresponding frame detail to rotationally orient said conformal pad relative to a pinna surface.

The replaceable conformal pad further comprises ultrasound transmitting gel on at least one surface.

In addition the replaceable conformal pad includes an enclosure in a sterile package including data describing a target area for said conformal pad.

An auricular vagus nerve stimulation system comprising:
(a) a power source;
(b) a controller configured to selectively activate a piezo driver according to a therapeutic regimen;
(c) a piezoelectric element energized by said piezo driver to generate ultrasonic radiation at a frequency above 1 megahertz;
(d) a replaceable conformal pad acoustically coupled to said piezoelectric element and configured to contact skin over the auricular vagus nerve; and
(e) a frame supporting said piezoelectric element and conformal pad against a user's ear.

Here, the system wherein the piezo driver comprises a Hartley circuit configured to resonate at a resonant frequency of the piezoelectric element.

In addition the system provides for a power source comprises a battery configured to operate at voltages of 3.3, 5, and/or 6 volts.

The system includes a controller that is configured to cycle between excitation and relaxation periods to provide a therapeutic frequency and amplitude sequence.

### BRIEF DESCRIPTION OF DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a schematic view showing a portion of the path of the auricular vagus nerve in the upper part of the anatomy.

FIG. 2 is a front plan view of a stimulator apparatus on the head of a subject.

FIG. 3 is a perspective view of a stimulator apparatus according to an embodiment of the present disclosure.

FIG. 4 is a side view showing relative positions of transducer and alignment feature components according to an embodiment of the present disclosure.

FIG. 5 is a cross-sectional side view that shows relative positions of components at the ear.

FIG. 6 is a schematic block diagram of the electrical components of the current invention.

FIG. 7 is an electrical schematic for a piezoelectric drive of the current invention.

FIG. 8 is a timing diagram of the piezo driver of FIG. 7.

FIG. 9 is a plot of applied energy by a controller.

FIG. 10 is a view of a frame supporting the electronic drive in accordance with the present invention.

FIG. 11 is a view of the other side of the frame of FIG. 10 having a transducer assembly.

FIG. 12 is a sectional view through the frame for the transducer assembly of FIG. 11.

FIG. 13 is a view of the frame having a removed replaceable conformal pad in accordance with the present invention.

FIG. 14 is a sectional view through the transducer assembly with a removed conformal pad.

FIG. 15 shows a headset in an alternate embodiment that provides a pair of ultrasound emitters.

### PARTS LIST

10 stimulator apparatus
11 headset
12 earpiece
15 crux of helix
20 flexure
22 transducer assembly
24 frame
25 frame detail
26 contact pad
28 alignment feature
30 headband
37 conformal pad skirt
38 conformal pad
39 conformal pad detail
40 piezo element
42 circuit board
43 wires
44 driver
46 speaker
48 power source
50 processor
V Vagus nerve
Va auricular Vagus nerve
F Force
U User
H Head
P Pinna
A Amplitude
W Wavelength

### DETAILED DESCRIPTION

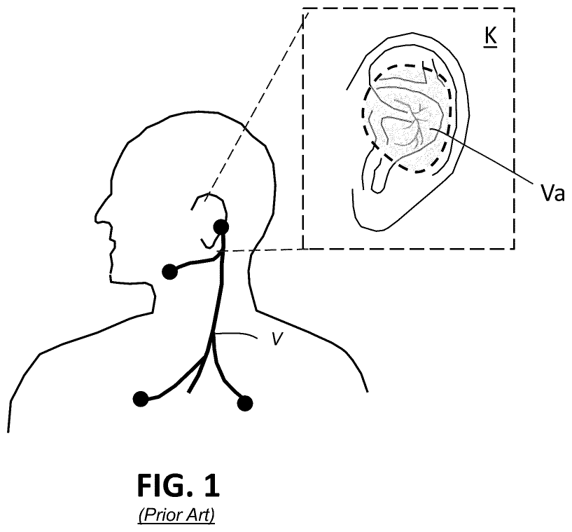

FIG. 1. illustrates a portion of the path of the auricular vagus nerve in the upper part of the anatomy.

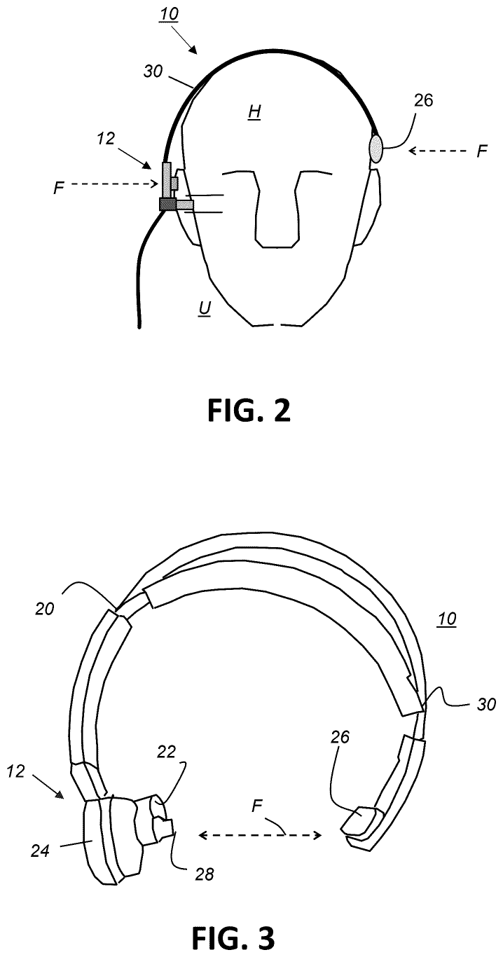

FIG. 2 is a front view of a stimulator apparatus 10 configured as headwear for stimulating an auricular vagus nerve of a user U. Stimulator apparatus 10 seats atop the head H of user U and is mounted on head H anatomy in order to dispose its emissive components in suitable position, and with suitable force, against the subject's ear. According to an embodiment, a headband 30, configured to extend across a parietal region of the head, flexes to provide a contact force F.

Referring to the perspective view of FIG. 3, stimulator headset 10 in accordance with the present disclosure includes an ultrasonic transducer assembly 22 provided on a headset. Headset 11 is apparatus that can be secured to head H. Headset 11 can be a set of brackets to form a frame, a cloth covering, or a clothing article referred to as a hat. Headsets can be mechanical structures that can be used to hold speakers and microphone or lenses in alignment to features on the head. Headset 11 has a frame 24 in the position of the headset “earpiece”, that is, in the position of the component that is intended for positioning against the ear; an earpiece 12 is labeled in FIGS. 2 and 3. For clarity, frame 24 is referred to herein as being part of the earpiece 12 of headset 30.

In the context of the present disclosure, relative to headset 11, the term “earpiece” is used as a convenient term that readily identifies the position of components that the headset apparatus 10 seats against the ear of user U. Earpiece 12 comprises frame 24 components of stimulator apparatus 10, along with any hardware and fixtures that are used to properly position frame 24 and its components suitably for ultrasound stimulation, as described in more detail herein. There may or may not be additional audio speakers within earpiece 12 in various embodiments.

Frame 24 houses the stimulating components suitably against the ear. Within frame 24, transducer assembly 22 is formed by embedding piezoelectric element 40 in epoxy and covering the assembly with conformal pad 38, which can be made of silicone, which transmits ultrasound. Silicone also provides a measure of friction for holding transducer assembly 22 in position against the skin surface. A contact pad 26, at the opposite end of flexure 20, provides the nesting force F that urges transducer assembly 22 into its position against the pinna P. Alignment feature 28, is spaced apart from transducer assembly 22, seats within ear canal to provide alignment that allows proper positioning of transducer assembly 22 against the pinna P surface.

Thus, using its combination of alignment feature 28, transducer assembly 22, and contact pad 26, along with tension provided through curved flexure 20, stimulator apparatus 10 provides the needed positioning and nesting force for locating signal emission where it is effective, and for maintaining this position without requiring user U to make more than rudimentary adjustments to suit individual anatomy.

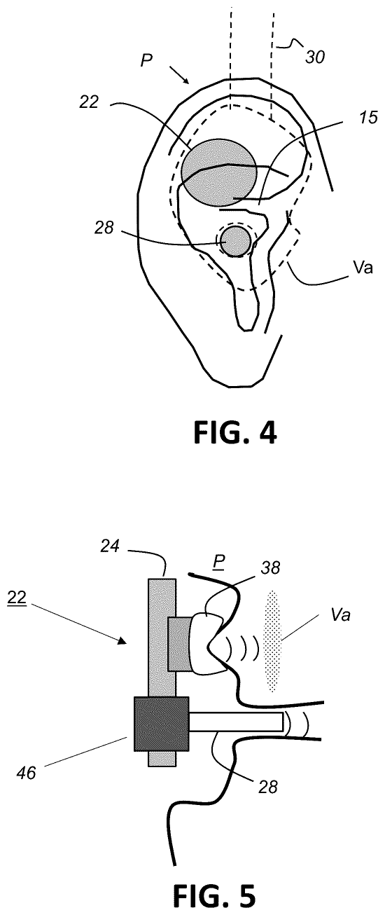

Headband 30 can be formed from metal and/or plastic or other materials and is configured to flex when positioned across the top of the head H, extending generally over the parietal or parietal/frontal region. Force F is applied against contact pad 26 for urging transducer assembly 22 against the pinna P surface. Contact pad 26 can be a compressive foam or other cushioning material for comfort of the user U. As shown in the plan view of FIG. 4, transducer assembly 22 is positioned and aligned over the crux of helix area 15 of pinna P dimensionally by alignment feature 28 that is configured to extend into the ear canal. Transducer assembly 22 is positioned to contact the area of auricular Vagus nerve Va.

FIG. 5 is a cross-sectional side view that shows relative positions of frame 24 components at the ear. Conformal pad 38 of transducer assembly 22 is pressed against pinna P, to transmit the stimulating ultrasound energy. Alignment feature 28 can be a molded pin that seats at least partially within ear canal to position device transducer assembly 22. According to an embodiment of the present disclosure, an optional audio signal can be provided to user U through alignment feature 28, acting as an audio “earpiece” as represented in FIG. 5. This audible signal can help to assure user U that the ultrasound transducer assembly 22 is being energized and actuated and that the ultrasound signal, otherwise imperceptible to the subject in many cases, is being emitted.

Ultrasonic radiation is functionally blocked though air, and a pathway from piezo element 40 to auricular Vegas nerve Va must pass through ultrasonic conductive materials. Piezo element 40 is embedded in epoxy to transmit ultrasonic radiation. Epoxy is an effective conductor of ultrasound radiation. The epoxy can be filled with material that improves the energy transmission from piezo element 40 to conformal pad 38. Conformal pad 38 is designed to conform to the surface of pinna P. In the preferred embodiment, conformal pad 38 is made of 40 durometer silicone rubber. Silicon rubber has physical properties that are comparable to human tissue, and transmits ultrasonic radiation with little loss. Alternatively soft urethane, which has good matching acoustic properties to tissue, can be used. A significant feature of the surface of pinna P is a crease, the crux of helix 15, in the center of Pinna P.

In this invention, conformal pad 38 has detail generally matching the surface of crux of helix 15. In the preferred embodiment, the design of stimulator apparatus 10 positions transducer assembly 22 over crux of helix 15. Alternatively, if transducer assembly 22 is positioned over other areas of auricular vagus nerve Va in Pinna P can be molded to generally conform to the alternative target areas. The structure of the stimulator apparatus 10 can be designed to align piezo transducer to any selected area of head H.

Conformal pad 38 can be made of an elastomer such as silicone rubber or polyurethane or materials having flexibility and acoustic impedance similar to living tissue. According to an embodiment, conformal pad 38 is formed from silicone rubber, with a hardness of 40A Shore durometer. Conformal pad 38 can be molded to be conformal with crux of helix 15 and with the floor of the concha C in order to more closely couple ultrasonic energy from transducer assembly 22 through the skin and thence to auricular vagus nerve Va. Conformal pad 38 can have multiple layers, using materials having suitable acoustical impedance.

Transmission efficiency is a consideration for selection and configuration of conformal pad 38. Acoustic impedance of pad 38 material is determined as a product of material density and speed of sound within the material. According to an embodiment of the present disclosure, silicone rubber has an acoustic impedance value that is conformable to skin tissue at the ear and can have a degree of effectivity without the use of acoustical gel, such as gel materials typically used with conventional ultrasound scanners, for example. Such gels can be water for acoustic coupling combined with a thickening agent to increase the viscosity of the ultrasound gel.

In the invention conformal pad 38 has a surface that contacts skin over the auricular vagus nerve Va. A flexure and contact pad arrangement is provided to forcibly urge conformal pad 38 to the skin surface. In the invention, a coupling fluid covers conformal pad 38 to improve ultrasound transmission to vagus nerve V. In the invention, the coupling fluid contains therapeutic chemistry, such as cannabis extract, to both improve ultrasound transmission and provide additional chemical therapeutic relief to a user.

Conventional ultrasound equipment can be bulky and require external cabling for routing drive signals to a suitable transducer probe or similar device. In order to provide a wearable device, however, the Applicant's design is scaled to incorporate the power, control logic, drive circuit, and transducer within headset 30 of apparatus 10.

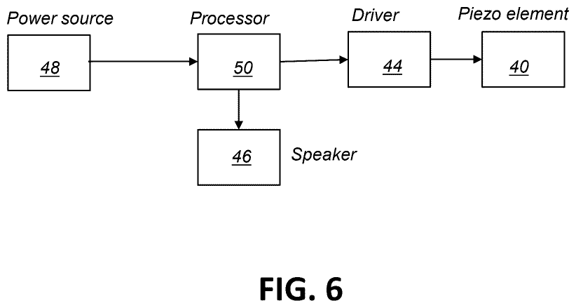

FIG. 6 is a schematic block diagram that shows drive components of the stimulator apparatus according to an embodiment of the present disclosure. A power source 48 provides battery or other electrical energy to stimulator apparatus 10. According to an embodiment, power source 48 is a single-use or rechargeable battery contained within the device. According to an alternate embodiment, power source 48 is external, with a power cable provides power from the external power source 48 to earpiece 12. Where battery 36 is rechargeable, a charging port can be provided on frame 24. Alternately wireless power transfer can be used for battery re-charging.

A controller 50, such as a microprocessor, is configured to selectively activate a piezo driver 44 to energize piezoelectric element 40 of transducer assembly 22. Controller 50 operates on piezo driver 44 according to a therapeutic regimen, as described subsequently. The waveform generated from driver 44 circuitry excites piezoelectric element 40 to vibrate at a resonant frequency in the ultrasound region.

As noted previously, ultrasound emission lies outside the range of human perception. Thus, it can be impossible for the wearing subject S to ascertain whether or not the ultrasound device is operating. An optional speaker 46 can be used to provide an audible signal that indicates active ultrasound emission. Different audible signals, such as different tones, can indicate phases of operation, including start operation, active operation, and end of a therapeutic session. Optionally, the audible indication can be in the form of a spoken statement or one or more acoustic tones.

According to an embodiment of the present disclosure, a constant tone between about 30-60 Hz can be used to provide a calming indicator signal that is audible to the wearing subject. According to an alternate embodiment of the present disclosure, speaker 46 can provide random noise with various frequency distributions, such as “brown” noise or “green” noise, held to be a variant of white noise, for example. Combining therapeutic aural sound stimulus with ultrasonic stimulation of the vagus nerve can improve the therapeutic effectiveness of apparatus 10.

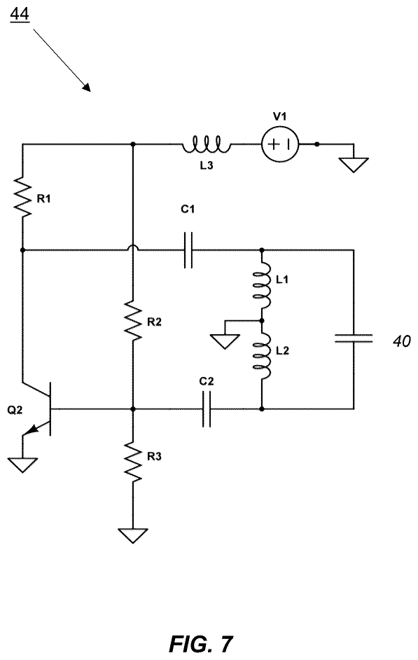

FIG. 7 is an electrical schematic for a piezoelectric drive of the current invention. Piezo driver 44 is a Hartley circuit which has inductors L1 and L2 and capacitors C1 and C2 that resonate at the resonant frequency of piezo transducer 22. Transducer 22 is designed to resonate above 1 megahertz to limit penetration of energy from transducer 22 into human head 10. Frequencies above one-megahertz limits energy flow to the areas around vagus nerve 12. Transducer 22 has a very low capacitance relative to the Hartley circuit and follows the voltage oscillations between the poles. The alternating voltage across transducer 22 generates ultrasonic radiation that is emitted from the two faces o transducer 22.

A first pole of resonance, between L1 and C1, can store energy as a high positive voltage. An opposing negative voltage occurs at a second pole between L2 and C2. The voltage potential between pole 1 and pole 2 causes stored energy to flow from the first pole to the second pole. Inductors L1 and L2 develop a magnetic field that drives the charge into the second pole. The voltage across poles one and two is reversed by the movement of energy from pole 1 to pole2. Resistances in the circuit and the parasitic load form transducer 22 causes energy loss during resonance, and the circuit will decay rapidly without the addition of energy.

Resistors R2 and R3 provide a reference voltage define an ON voltage for transistor Q2. The ON voltage for transistor Q2 is selected to add energy to the resonant circuit at a time that maximizes the peak voltage in the resonant circuit. The maximized voltage maximizes the energy emitted by transducer 22. R1 limits the current that is supplied to piezo driver 44. Inductor L3 provides a secondary resonance to piezo driver 42 which improves peak voltage in the resonance circuit and increase power output from transducer 22.

Piezo driver 42 operates efficiently using a minimum number of components in a compact space compared to other commercial products. Piezo driver circuit is designed to operate at low voltages that are readily available, such as 5 volts from a USB cable or 3.3 or 6 volts from batteries. The preferred embodiment requires that the components be selected to operate with the supplied voltage. Commercial ultrasound units typically use high voltages and power for ultrasound generation, which prevents untethered portability of such as battery for power source 48. A circuit in accordance with the present invention creates a small portable stimulation device.

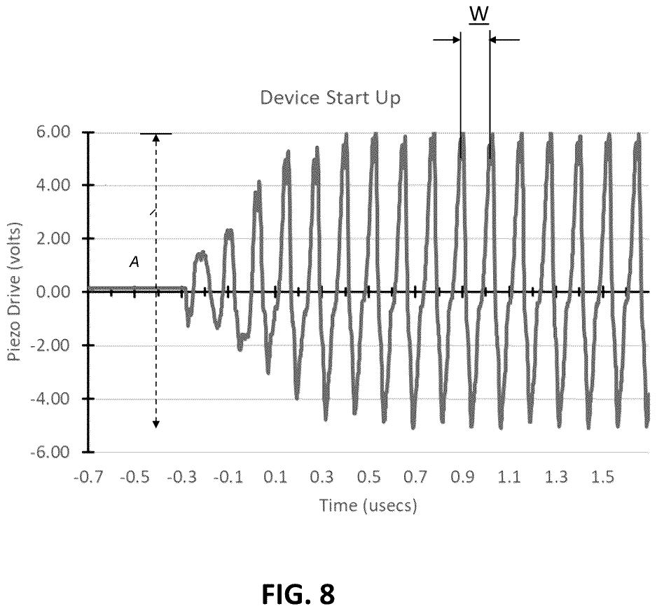

FIG. 8 is a timing diagram of the piezo driver of FIG. 7. Once stabilized, the energizing signal is provided with an amplitude A, at a suitable pulse width and frequency for excitation of piezoelectric element 40. In the embodiment shown, the drive voltage oscillates between about +6.00 and −5.00V. Piezo driver 44 applies voltage to piezoelectric element 40 to generate ultrasound mechanical vibration at frequencies above human hearing range. The vibration frequency, over wavelength W, corresponds to the megahertz (MHz) range in order properly excite piezoelectric element 40 and generate a signal that penetrates deeply into pinna P for excitation of vagus nerve V. According to an embodiment of the present disclosure, transducer assembly 22 has a center frequency near 8 MHz, in a range that limits ultrasound energy to the auricular vagus nerve area. Signal amplitude A is set to a range of values that excite vagus nerve V without damaging neural tissue through cavitation.

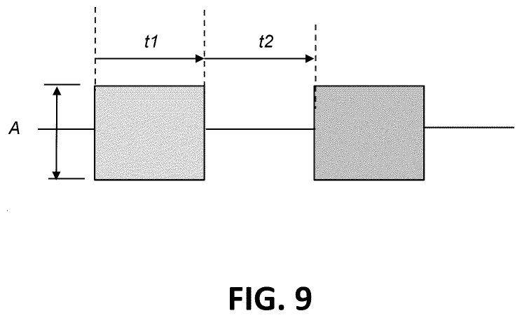

FIG. 9 is a plot of applied energy by a controller. Nerves react electrochemically measured in a few milliseconds and need a rest time to reset. During a time period t1, ultrasonic energy is provided for ultrasound generation and consequent auricular vagus nerve Va excitation, with pulse amplitude or power level A. Controller 50 then turns off the pulse excitation for a time period t2. It is believed that this cycling of excitation between a predetermined power amplitude 56 and zero power at low frequency provides a therapeutic sequence of excitation and relaxation. During the relaxation period t2, with excitation removed, vagus nerve V will reset biochemically.

According to an embodiment of the present disclosure, a duty cycle of 50% can be used. An excitation time t1 can be set to 30 msec, with relaxation time t2 also set to 30 msec. Repeated cycling between the two states as shown can be executed for a period of time that is held to be therapeutic, such as for 5 minutes, for example. Other t1/t2 timing intervals can be used.

Piezoelectric element 40 can be formed from any of a number of suitable materials. Piezoelectric element 40 can be a piezoelectric plate formed from PZT (Lead zirconate titanate), such as PZT-5A, generally referred to as a piezoelectric ceramic or piezoelectric crystal. Exemplary nominal dimensions for piezoelectric element 40 in plate form can be about 10 mm diameter, 0.28 mm thickness. More generally, piezoelectric materials used for piezoelectric element 40 can be formed from both natural and synthetic materials. Naturally occurring piezoelectric materials include quartz SiO2, berlinite, sucrose, Rochelle salt NaKC4H4O6·4H2O, topaz, and a tourmaline group of minerals. Synthetic piezoelectric materials are further classified as synthetic crystals, ceramics, and polymers. Synthetic piezoelectric crystals include gallium orthophosphate (GaPO4) and langasite (La3Ga5SiO14). Synthetic piezoelectric ceramics include barium titanate (BaTiO3), lead titanate (PbTiO3), lead zirconate titanate, potassium niobate (KNbO3), lithium niobate (LiNbO3), lithium tantalate (LiTaO3), sodium tungstate (NaWO3), zinc oxide (ZnO), aluminium nitride (AlN), and scandium-aluminum nitride. Synthetic piezoelectric polymers can include materials such as polyvinylidene fluoride (PVDF) and copolymers of vinylidene fluoride (VDF) with trifluoroethylene (TrFE), or with tetrafluroethylene (TeFE).

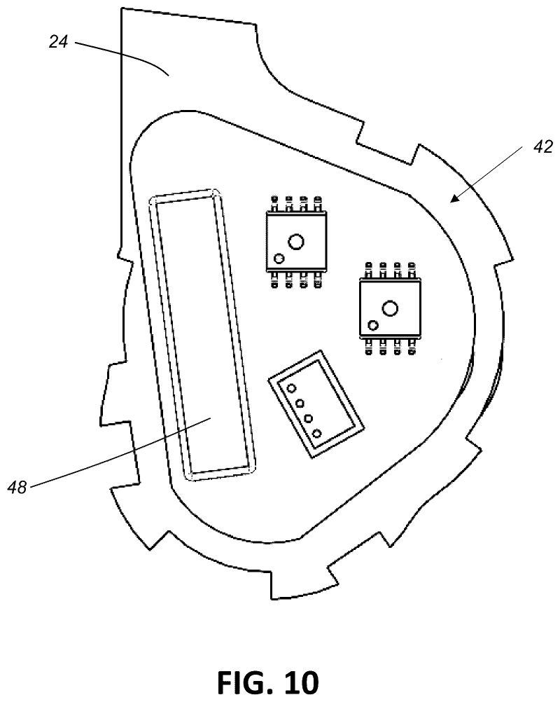

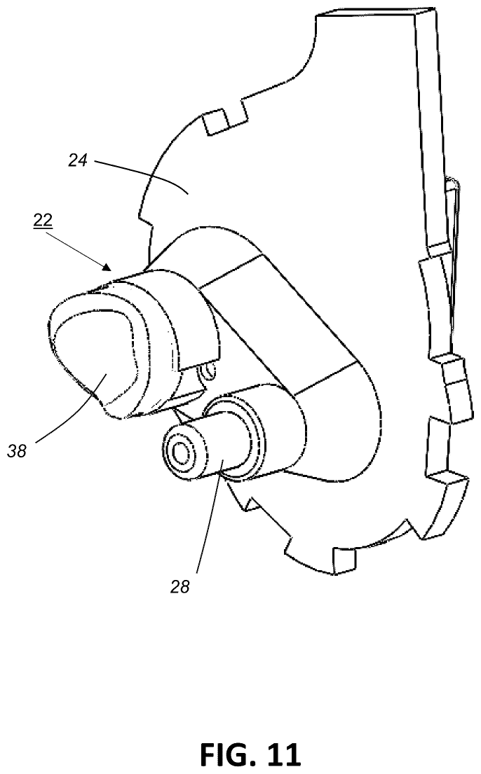

FIG. 10 is a frame holding electronics in accordance with the present invention. A circuit board 42 contains electrical drive components of FIG. 6, and is mounted on frame 24. Power source 48 is a battery mounted on circuit board is mounted onto board 46 to power the electronics. FIG. 11 is a section view of the side opposite the drive electronics in accordance with the present invention. The opposite side of frame 24 having alignment feature 28 and transducer assembly 22, and conformal pad 38. Transducer assembly 22 on frame 24 includes an epoxy encased piezo element 40 secured to frame 24. Conformal pad 38 contacts encased piezo element 40.

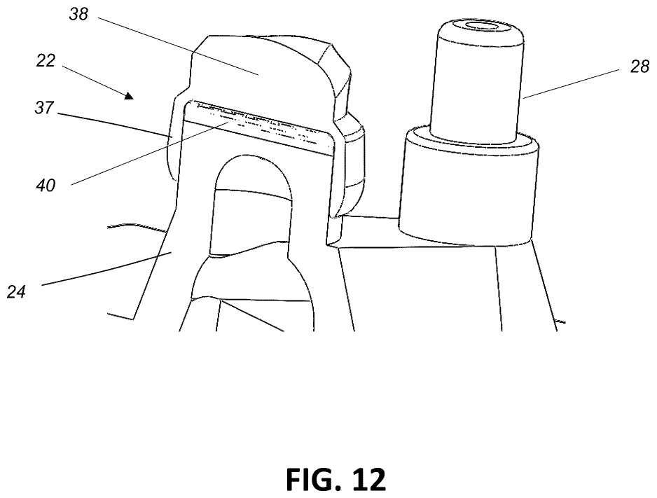

FIG. 12 is a sectional view through the frame for the transducer assembly of FIG. 11. Transducer assembly 22 is a piezo element 40 mounted in epoxy. Conformal pad 38 is secured to frame conforms to the surface of epoxy encased piezo element 40 and extends around the outside of frame 24. Conformal pad 38 is held on place by the elasticity of the silicone rubber to frame 24. The surface of piezo element 40 is coated with ultrasound gel to efficiently transfer ultrasonic energy to conformal pad 38. The invention discloses a removable conformal pad 38 which has a layer of ultrasound gel at the surface contacting piezo element 40. In another embodiment conformal pad 38 is coated on both the surface facing piezo element 40 and, on the surface, contacting the surface of pinna P.

Conformal pad 38 includes conformal pad skirt 37 which is formed to grip cylindrical detail on frame 24. Conformal pad is made of elastic silicone rubber and conformal pad skirt 37 is molded slightly smaller than the contact areas on frame 24. Conformal pad skirt 37 stretches to create a securing force for conformal pad 26.

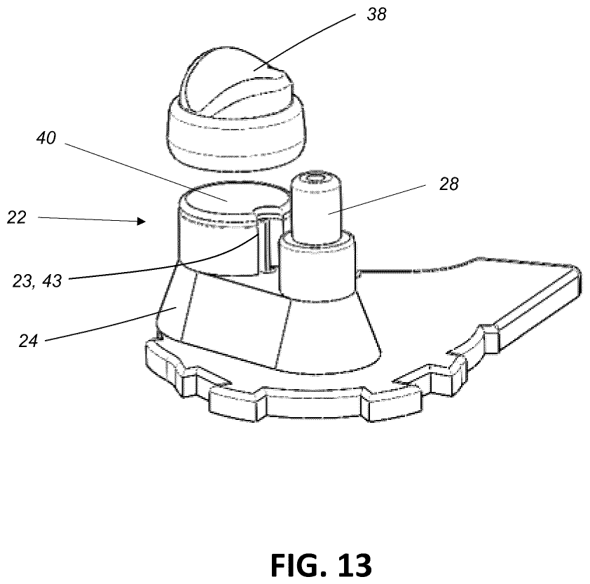

FIG. 13 is a view of the frame having a replaceable conformal pad in accordance with the present invention. In the drawing, conformal pad 38 is separated from stimulator apparatus 10. Piezo element 40 is encased in epoxy and presents and epoxy surface to the contact are of conformal pad 38. The surface of conformal pad 38 is designed to generally align with the crux of helix and has a surface that must be aligned rotationally on the surface of transducer assembly 22 to be oriented relative to the surface of the crux of helix 15. Piezo element 40 has two wires 43 which are set into a notch, frame detail 25, in frame 24. Frame detail 25 provides rotational orientation of conformal pad 38 to crux of helix 15 when stimulator apparatus 10 is mounted on head H.

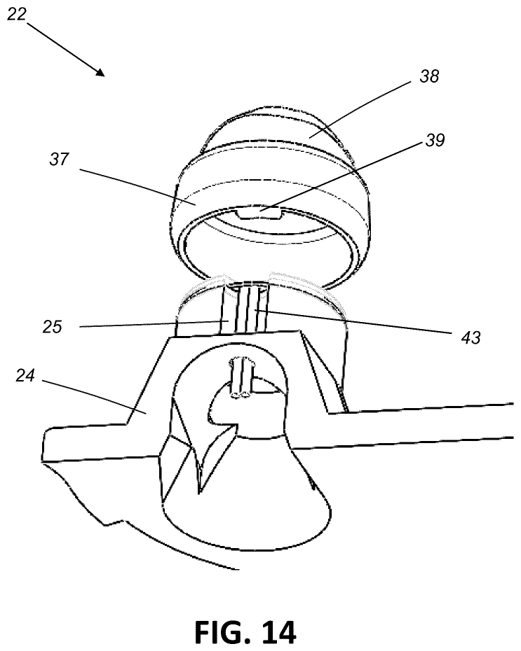

FIG. 14 is a sectional view through the transducer assembly with a removed conformal pad. Conformal pad 38 includes conformal pad detail 39 that engages with frame detail 25 to provide alignment of conformal pad 28 to stimulator apparatus 10. Conformal pad 38 is pressed onto frame 40 and can be rotated until conformal pad detail 39 and frame detail 25 are aligned. The rotation aligns the contacting surface of conformal pad 38 to the engaging surface on Pinna P.

A selectively attachable conformal pad 38 can have other embodiments. Conformal pad skirt 37 can be formed from a rigid material that engages securing detail on frame 24. Securing detail could be a mechanical latch. Securing detail can be magnetic elements embedded in conformal pad skirt 37 and frame 24. Conformal Pad detail 39 and fame detail 39 can be convex or concave details that are keyed to orient conformal pad 26 to a surface in concha C, including crux of helix 15.

In another embodiment, Conformal pad 38 can be a simple rounded surface that generically contacts areas of concha C. In the embodiment, the rotational orientation of conformal pad 38 is not needed, and detail to interlock conformal pad 38 and frame 24 are nor needed.

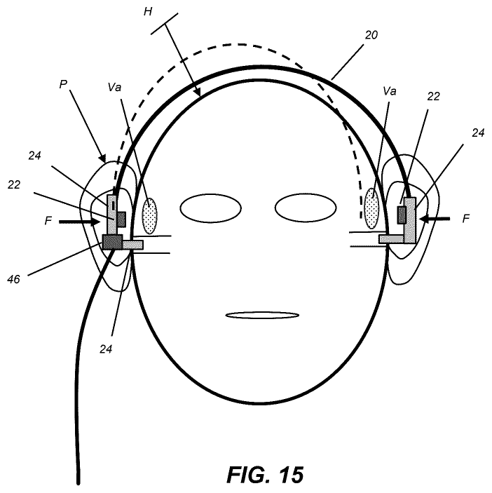

FIG. 15 shows a headset in an alternate embodiment that provides a pair of ultrasound emitters. In the FIG. 15 embodiment, the needed force F for urging transducer assembly 22 against the pinna P on each side of the head is provided by a single flexure 20. According to an embodiment of the present disclosure, frames 24 used in headband 30 are mirror images of each other, both attached to flexure 20, each frame 24 provided with its own circuit board 34. Power can be provided by a common external power source 48, with power supplied to a first circuit board, then routed along a cable to the second circuit board.

Details in pinna P are generally mirrored image of each other. In paired case of contact with the crux of helix 15, mirror image conformal pads 38 are used to ensure good contact to both crux of helix 15. A right and left sided conformal pad 38 is required in the case of a transducer that can be mounted over either pinna P. User U selects the appropriate conformal pad 38 based on the concha area being stimulated.

The surfaces of the concha can differ between users U, requiring different conformal pads 38 that ensure good energy transmission. The invention provides the ability to select the best conformance configuration from an array of different conformal pads 38.

Conformal pad 38 can include packaging that secures conformal pad 38 in a sterile package. The package can further include coupling gel on the surface contacting piezo element 40 and coupling gel on the surface that contacts pinna P. Packaging for a given conformal pad 38 can include data that describes the target area for conformal pad 38, such as the right or left side of the head, and data describing a given surface of pinna P.

The invention has been described in detail, and may have been described with particular reference to a suitable or presently preferred embodiment, but it will be understood that variations and modifications can be effected within the spirit and scope of the invention. For example, headset apparatus 10 can be incorporated for operation within a closed loop system that includes sensors for detecting conditions or patterns in subject physiology. The presently disclosed embodiments are therefore considered in all respects to be illustrative and not restrictive. The scope of the invention is indicated by the appended claims, and all changes that come within the meaning and range of equivalents thereof are intended to be embraced therein.

1. A headset for a user comprising:
(a) a headband configured to secure said headset to a user's head;
(b) one or more ultrasound transducers on said headset configured to press against an auricular vagus nerve; and
(c) a replaceable conformal pad over said ultrasound transducers that contacts a surface of an ear over said auricular vagus nerve.

2. The headset of claim 1 wherein said conformal pad has features that conform to a surface of an ear over said auricular vagus nerve.

3. The headset of claim 1 wherein said conformal pad is comprised of an elastomer.

4. The headset of claim 2 wherein details of said replaceable conformal pad aligns said conformal pad to said surface of the ear over the auricular vagus nerve when attached to said headset.

5. The headset of claim 1 wherein said conformal pad is enclosed in a sterile package.

6. The headset of claim 5 wherein:
(a) said conformal pad has ultrasound transmitting gel on a surface contacting an ear; and
(b) said conformal pad supports ultrasonic conducting gel on a surface receiving ultrasonic energy.

7. The headset of claim 6 wherein said gel in contact with a pinna contains psychotherapeutic substances.

8. The headset of claim 1 further comprising an alignment feature spaced apart from said transducer and configured to seat within an ear canal to position the transducer assembly against a pinna surface.

9. The headset of claim 1 wherein the ultrasound transducer comprises a piezoelectric element embedded in epoxy.

10. The headset of claim 9 wherein said piezoelectric element is formed from PZT-5A.

11. The headset of claim 1 wherein said conformal pad is formed from liquid silicone rubber (LSR) having a hardness of approximately 40A Shore durometer.

12. The headset of claim 1 further comprising a controller configured to provide ultrasonic energy during a first time period and discontinue excitation during a second time period in a therapeutic cycling sequence.

13. The headset of claim 12 wherein a duty cycle is approximately 50% with excitation and relaxation times of approximately 30 msec each.

14. The headset of claim 1 wherein a transducer assembly has a center frequency at or about 8 MHz.

15. The headset of claim 1 further comprising a speaker configured to provide an audible signal indicating active ultrasound emission.

16. The headset of claim 1 wherein said conformal pad includes a skirt portion configured to grip a frame, wherein said skirt portion is molded slightly smaller than contact areas on said frame such that said skirt stretches to create a securing force.

17. The headset of claim 1 wherein said conformal pad includes an alignment detail configured to engage a corresponding frame detail to rotationally orient said conformal pad relative to said pinna surface.

18. The headset of claim 1 comprising a pair of ultrasound transducer assemblies configured for simultaneous stimulation of both ears.

19. A replaceable conformal pad for an auricular vagus nerve stimulator comprising:
(a) an elastomeric body having a contact surface shaped to conform to a crux of helix of a pinna;
(b) a skirt portion configured to grip a frame of said nerve stimulator; and
(c) an alignment detail configured to engage a corresponding frame detail to rotationally orient said conformal pad relative to a pinna surface.

20. The replaceable conformal pad of claim 19 further comprising ultrasound transmitting gel on at least one surface.

21. The replaceable conformal pad of claim 19 enclosed in a sterile package including data describing a target area for said conformal pad.

22. An auricular vagus nerve stimulation system comprising:
(a) a power source;
(b) a controller configured to selectively activate a piezo driver according to a therapeutic regimen;
(c) a piezoelectric element energized by said piezo driver to generate ultrasonic radiation at a frequency above 1 megahertz;
(d) a replaceable conformal pad acoustically coupled to said piezoelectric element and configured to contact skin over the auricular vagus nerve; and
(e) a frame supporting said piezoelectric element and conformal pad against a user's ear.

23. The system of claim 22 wherein said piezo driver comprises a Hartley circuit configured to resonate at a resonant frequency of the piezoelectric element.

24. The system of claim 22 wherein a power source comprises a battery configured to operate at voltages of 3.3, 5, and/or 6 volts.

25. The system of claim 22 wherein a controller is configured to cycle between excitation and relaxation periods to provide a therapeutic frequency and amplitude sequence.
